(19) United States
(12) Patent Application Publication
(10) Pub. No.: US 2024/0367300 A1
(43) Pub. Date: Nov. 7, 2024

(54) COIL FEEDING DEVICE FOR ELECTROPORTABLE TOOLS

(71) Applicant: Illinois Tool Works Inc., Glenview, IL (US)

(72) Inventor: Frederic Nayrac, Bourg-lès-Valence (FR)

(21) Appl. No.: 18/683,727

(22) PCT Filed: Sep. 7, 2022
(86) PCT No.: PCT/US2022/042690

§ 371 Date: Feb. 14, 2024

(30) Foreign Application Priority Data
Sep. 8, 2021 (FR) FR2109411

(51) Int. Cl. B25C 1/06

(52) U.S. Cl. CPC B25C 1/06

(57) ABSTRACT

A power supply device for coils for a portable electric tool, said portable electric tool comprising a casing forming a cylinder in which a movable piston slides between a start position at the start of travel of the piston and an end position at the end of travel of the piston. More specifically, the power supply device comprises: at least one battery intended to supply power to the coils; a first, fixed coil located in the cylinder at the start of travel of the movable piston; a second, movable coil located facing the first, fixed coil and secured to the movable piston; and power supply routing mechanisms for the second, movable coil, these mechanisms being secured to the piston and intended to channel the power supply from the battery so as to supply power, preferably in series, to the first, fixed coil and the second, movable coil. Each power supply routing mechanism being configured to cooperate with one of two connectors, each of which is connected to one and the same terminal of the battery over at least a displacement distance (X) of the piston between the start position and the end position of the piston, said distance (X) being less than or equal to a distance (D) corresponding to the maximum distance travelled by the piston between the start position and the end position.

### PRIORITY CLAIM

This application is a national stage application of PCT/US2022/042690, filed on Sep. 7, 2022, which claims priority to and the benefit of French Application No. 2109411, filed Sep. 8, 2021, the entire contents of which are incorporated herein by reference.

### TECHNICAL FIELD

The present disclosure relates to a battery-powered portable electric device. More specifically, the present disclosure relates to a portable electric device of the nail fastener driving tool type that makes it possible to drive nails into a support.

### BACKGROUND

Well-known portable electric tools use an electric motor driving a flywheel or a geared motor compressing a spring in order to store mechanical energy that makes it possible to set movable parts of the portable electric device in movement, such as for example a piston fitted with a firing pin in the case of a nail fastener driving tool.

The drawbacks of this type of solution are numerous, in particular a reduced service life (in particular wear of the coils), weak output and high weight. However, there is also a rather short service life and/or battery charge in the event of intensive use.

It would therefore be advantageous to provide the operator with a portable electric tool which alleviates the problems cited.

### SUMMARY

The present disclosure relates to a power supply device for coils for a portable electric tool, said portable electric tool comprising a casing forming a cylinder in which a movable piston slides between a start position at the start of travel of the piston and an end position at the end of travel of the piston. The present disclosure also provides a coil feeding device for electroportable tools.

More specifically, the power supply device comprises: (1) at least one battery intended to supply current and voltage to the coils; (2) a first, fixed coil located in the cylinder at the start of travel of the movable piston; (3) a second, movable coil located facing the first, fixed coil and secured to the movable piston; and (4) a power supply routing mechanism for the second, movable coil, these mechanisms being secured to the piston and intended to channel the power supply from the battery so as to supply power to the first, fixed coil and the second, movable coil. Each power supply routing mechanism being configured to cooperate with connectors, each of which is connected to one and the same terminal of the battery over at least a displacement distance X of the piston between the start position and the end position of the piston, said distance X being less than or equal to a distance D corresponding to the maximum distance travelled by the piston between the start position and the end position.

Moreover, the power supply routing mechanisms can be in electrical contact with said connectors over a distance X equal to the length of said power supply routing mechanism.

Advantageously, the second, movable coil is supplied with power over a distance X equal to said distance D by a scraper contact between an internal face of the casing and the movable coil.

In addition, the power supply routing mechanisms can be located on either side of the longitudinal axis.

According to one feature, the power supply routing mechanisms can be located along the longitudinal axis.

According to another feature, the coils are, for example but not exclusively, concentric about the longitudinal axis 30 of the movable piston.

Advantageously, the power supply routing mechanisms are intended to channel the power supply from the battery so as to supply power in series to the first, fixed coil and the second, movable coil.

### BRIEF DESCRIPTION OF THE SEVERAL VIEWS OF THE DRAWINGS

Embodiments of the present disclosure will now be described solely by way of example with reference to the drawings of the following figures.

FIG. 1 illustrates an example embodiment of the present disclosure.

FIG. 2 illustrates in greater detail the scraper contact enabling the supply of power to the coils along the cylinder in accordance with one example embodiment of the present disclosure.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connection of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, etc., are not intended to be limited to direct mounting methods, but should be interpreted broadly to include indirect and operably coupled, mounted, connected, and like mounting methods. This specification is intended to be taken as a whole and interpreted in accordance with the principles of the present disclosure and as understood by one of ordinary skill in the art.

To avoid any doubt, all the features described here likewise apply to any aspect of the present disclosure.

In the context of the present application, it is expressly provided that the various aspects, embodiments, examples and alternatives mentioned in the above paragraphs, in the claims and/or in the description and the following drawings, and in particular the individual features thereof, may be taken independently or in any combination. In other words, all of the embodiments and/or the features of any embodiment may be combined in any way, unless these features are incompatible.

To avoid any ambiguity, the terms “can”, “may”, “and/or”, “for example”, “for example” and any other similar terms used in the present document should be interpreted as nonlimiting, such that any feature described in this way does not necessarily have to be present. Specifically, any combination of optional features is expressly envisaged without departing from the scope of the present disclosure, whether they are expressly mentioned or not. The applicant reserves the right to modify any originally filed claim or to consequently file any new claim, including the right to modify any originally filed claim such that it depends on and/or incorporates any feature of any other claim, even if it was not originally claimed in this way.

Additionally, a person skilled in the art will appreciate that numerous variants of the embodiments described are conceivable without departing from the scope of the present disclosure.

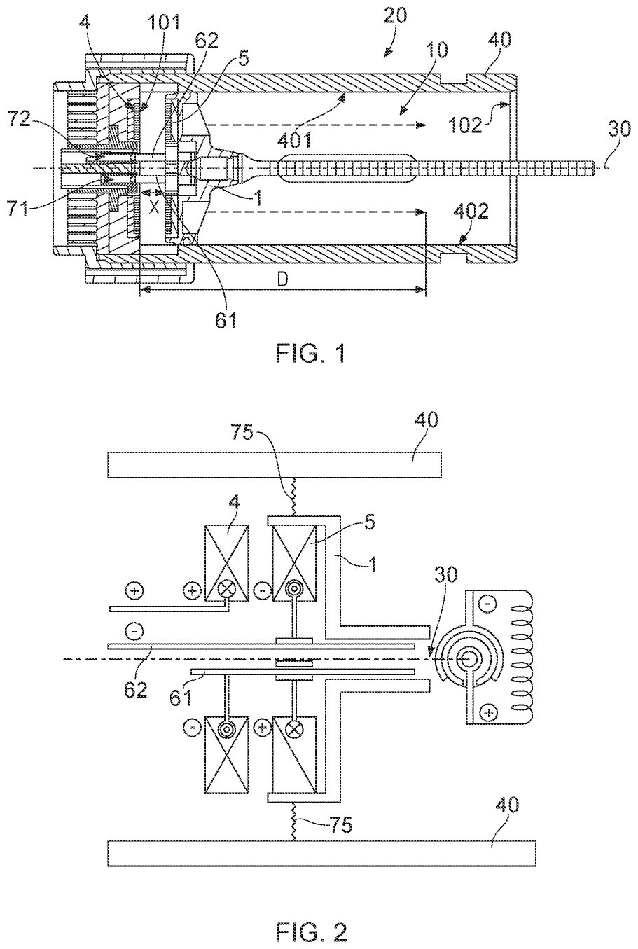

With reference now to FIGS. 1 and 2, FIG. 1 illustrates a device for supplying power to coils of a portable electric tool 20. This portable electric tool comprises a casing 40 forming a cylinder 10 in which a movable piston 1 slides between a start position at the start of travel of the piston 1 and an end position at the end of travel of the piston 1. Advantageously, this device comprises at least one battery intended to supply power to the coils, a first, fixed coil 4 located in the cylinder 10 at the start of travel of the movable piston 1, and a second, movable coil 5 located facing the first, fixed coil 4 and secured to the movable piston 1.

It also comprises power supply routing mechanisms 61 and 62 for the second, movable coil 5, these mechanisms being secured to the piston and intended to channel the power supply from the battery so as to supply power, preferably in series, to the first, fixed coil 4 and the second, movable coil 5. Such an arrangement for supplying power to the coils includes channeling the power supply wires of the coils via the casing and ensuring the supply of power to the latter via a scraper contact 75 between the coil and the casing 40.

In addition, each power supply routing mechanism is configured to cooperate with connectors 71 and 72, each of which is connected to one and the same terminal of the battery over at least a displacement distance X of the piston between the start position and the end position of the piston, said distance X being less than or equal to a distance D corresponding to the maximum distance travelled by the piston between the start position and the end position.

Preferably, the power supply routing mechanisms 61 and 62 are in electrical contact with said connectors 71 and 72 over a distance X equal to the length of said power supply routing mechanisms 61 and 62.

More specifically, the second, movable coil 5 is supplied with power over a distance X equal to said distance D by a scraper contact 75 between an internal face 401 and/or 402 of the casing 40 and the movable coil 5.

According to one embodiment, power supply routing mechanisms 61 and 62 are located on either side of the longitudinal axis 30 so as to obtain a compact device.

Optionally, the power supply routing mechanisms 61 and 62 are located along the longitudinal axis 30.

1-6. (canceled)

7: A power supply device for coils for a portable electric tool, the portable electric tool including a casing forming a cylinder, a piston moveable in the cylinder from a start position to an end position and back to the start position, said power supply device comprising:
a first fixed coil located in the cylinder at the start position of the movable piston;
a second movable coil located facing the first fixed coil and secured to the piston; and
power supply routing mechanisms secured to the piston and configured to channel power supply from a battery to supply power to the first fixed coil and the second movable coil,
wherein each power supply routing mechanism is configured to cooperate with one of two connectors, each of which is connected to one and the same terminal of the battery over at least a displacement distance of the piston between the start position and the end position of the piston, the displacement distance being less than or equal to a distance corresponding to a maximum distance travelled by the piston from the start position to the end position.

8: The power supply device of claim 7, wherein the power supply routing mechanisms are in electrical contact with the connectors over the displacement distance that is equal to a length of the power supply routing mechanisms.

9: The power supply device of claim 7, wherein the second movable coil is supplied with power by a scraper contact between an internal face of the casing and the movable coil.

10: The power supply device of claim 7, wherein the power supply routing mechanisms are located on either side of a longitudinal axis of the portable electric tool.

11: The power supply device of claim 7, wherein the power supply routing mechanisms are located along a longitudinal axis of the portable electric tool.

12: The power supply device of claim 7, wherein the power supply routing mechanisms are configured to channel the power supply from the battery to supply power in series to the first fixed coil and the second movable coil.
